(19) United States
(12) Patent Application Publication
(10) Pub. No.: US 2009/0173244 A1
(43) Pub. Date: Jul. 9, 2009

(54) METHOD OF DETERMINING A PATTERN POSITION IN A GOLD FOIL PRINTER

(76) Inventor: Byung Jun Song, Gyonggi-do (KR)

Correspondence Address: BERENATO, WHITE & STAVISH, LLC, 6550 ROCK SPRING DRIVE, SUITE 240, BETHESDA, MD, 20817, US

(21) Appl. No.: 11/718,025

(22) PCT Filed: Sep. 2, 2005
(86) PCT No.: PCT/KR05/02920

§ 371 Date: Mar. 6, 2009

(51) Int. Cl. B44C 1/24

(52) U.S. Cl. 101/32

(57) ABSTRACT

The pattern position determining method includes the steps of: preparing a transparent film on which latticed holes are indicated as in an upper mold on which latticed fixing holes are formed; placing the transparent film on printing paper; placing a gold foil printing pattern forming film on the transparent film, to then indicate positions of fixing holes on the gold foil printing pattern forming film; and etching or numerically controlled engraving the pattern forming film to thereby obtain a pattern forming member from which a pattern and the positions of the fixing holes protrude. A gold foil printing apparatus is completed by bolting and fixing the pattern forming member onto the fixing holes of the upper mold. The gold foil printing apparatus makes the position of fixing the pattern forming member indicated during etching, to thereby accurately find the fixing positions of the pattern forming member more easily.

### TECHNICAL FIELD

The present invention relates to a method of determining a pattern position in a gold foil printer for printing a gold foil, and more particularly, to a method of determining a pattern position in a gold foil printer for printing a gold foil in which a pattern forming member is accurately fixed to and coupled with an upper mold more accurately to thereby improve a defect that a fine adjustment of a position in a process of coupling the pattern forming member with an upper mold should be performed.

### BACKGROUND ART

FIG. 1 is a schematic side cross-sectional view showing a conventional method of fixing a pattern in a gold foil printing apparatus.

Referring to FIG. 1, the conventional gold foil printing apparatus includes a lower mold 110 on which printing paper 102 is put, and an upper mold 120 which is positioned so as to be escalated at the upper portion of the lower mold 110, and compresses the printing paper 102 put on the lower mold 110, in which a gold foil film 101 is loaded on the upper surface of the printing paper 102.

Here, as enlarged, a pattern forming member 140 having a printing pattern 141 of a shape to be represented on the printing paper 102 is mounted on one surface of the upper mold 120 directed to the lower mold 110. Here, a chucking portion 150 includes a hinge pin 150a and a chucking rotational bar 150b.

In the gold foil printing apparatus, the printing paper 102 which is an object to be printed is positioned at a predetermined position on the upper surface of the lower mold 110, and then the upper mold 120 is made to descend at a state where the gold foil film 101 is positioned on the upper surface of the printing paper 102, so that the printing paper 102 is compressed between the lower mold 110 and the upper mold 120. Accordingly, the pattern forming member 140 is stamped in the form of unevenness on a printing surface of the printing paper 102 through the gold foil film 101. As a result, gold foil printing is accomplished on the printing paper 102.

When gold foil printing is performed through the upper mold 120, the position of the pattern forming member 140 which is fixed to and coupled with the upper mold 120 should be adjusted, which will be described below with reference to FIG. 2.

FIG. 2 is a bottom view schematically explaining a conventional method of fixing a pattern in a gold foil printing apparatus. As shown in FIG. 2, as a means for easily adjusting position of a gold foil which will be represented on printing paper 102, a plurality of latticed portions 122 for setting position of the pattern forming member 140 are formed on the lower surface of the upper mold 120 in the conventional pattern position determining method employed in the gold foil printing apparatus. The latticed portions 122 are of a shape of plotting paper or a scale which is transversely and longitudinally partitioned.

As a means for mounting the position-adjusted pattern forming member 140 on the lower surface of the upper mold 120, a pair of chucking portions 150 are provided on the lower surface of the upper mold 120. Each of the chucking portions 150 includes a hinge pin 150a and a chucking rotational bar 150b. The hinge pin 150a and the chucking rotational bar 150b are assembled at a corresponding position. Thereafter, a pair of the chucking rotational bars 150b are pivoted by a pair of the hinge pins 150a, respectively, to thereby support both ends of the pattern forming member 140 so that the pattern forming member 140 can be mounted at a predetermined position on the lower surface of the upper mold 120.

Here, in the case that the pattern forming member 140 is mounted on the lower surface of the upper mold 120 in this manner, the position of the pattern forming member 140 with respect to the upper mold 120 may be mismatched minutely. In this case, only the pattern forming member 140 may be moved and adjusted in the chucking portion 150. However, such an adjustment procedure is not so easy and burdensome, and thus an accuracy of the pattern position is lowered. Further, if the pattern forming member 140 mismatches the upper mold 120, the lower mold 110 should be separated and adjusted by an expert and then the pattern should be re-printed again in order to confirm whether the pattern forming member 140 matches the upper mold 120 in its position. This has caused workers to feel burdensome.

### DISCLOSURE OF INVENTION

### Technical Problem

To solve the above problems, it is an object of the present invention to provide a pattern position determining method for a gold foil printing apparatus in which a pattern forming member can be mounted on, fixed to and coupled with an upper mold so that a pattern printing position can be accurately set at a stroke.

It is another object of the present invention to provide a pattern position determining method in which a pattern forming member can be firmly fixed to thereby remarkably reduce printing inferiorities which can occur during a gold foil forming process.

### Technical Solution

To accomplish the above object of the present invention according to an aspect of the present invention, there is provided a method of determining position of a pattern in a gold foil printer in which a pattern forming member is fixed to and coupled with an upper mold on which latticed fixing holes are formed, the pattern position determining method comprising the steps of: preparing a transparent film on which latticed holes are indicated as in an upper mold on which predetermined latticed fixing holes are formed on the bottom thereof; placing the transparent film on printing paper on which printing is performed; placing a gold foil printing pattern forming film on the transparent film, to then indicate positions of fixing holes transmitted on the gold foil printing pattern forming film, if a gold foil printing pattern forming position is determined; and etching or numerically controlled engraving the pattern forming film with a predetermined metal member, to thereby obtain a pattern forming member from which a pattern protrudes and at least two of the positions of the fixing holes are indicated.

Preferably, the positions of the fixing holes in the pattern forming member protrude lower than that of the pattern, and a drilling groove is formed at the center thereof.

Preferably, the pattern forming member employed in the pattern position determining method for the gold foil printing apparatus according to the present invention can be formed in various forms in which the position determining fixing holes are formed on the bottom of the pattern forming member, or penetrate the pattern forming member.

Preferably, the pattern forming member employed in the pattern position determining method for the gold foil printing apparatus according to the present invention is fixed with a bolting member having a flat head so as to be fixed at a lower position than the protruded pattern.

### Advantageous Effects

As described above, the present invention provides a pattern position determining method for a gold foil printing apparatus in which a pattern forming member 40a or 40b is determined in position of an upper mold 20 more conveniently than the conventional art, to thereby reduce repetition of the working process in the conventional gold foil printing process, and mitigate fatigue of workers due to its repeated working process.

### BRIEF DESCRIPTION OF THE DRAWINGS

The above and other objects and advantages of the present invention will become more apparent by describing the preferred embodiments thereof in detail with reference to the accompanying drawings in which:

FIG. 1 is a schematic view explaining a conventional pattern position determining method in a gold foil printing apparatus in which essential parts of the gold foil printing apparatus are enlarged and illustrated;

FIG. 2 is a plan view showing an upper mold illustrating the conventional pattern position determining method in a gold foil printing apparatus of FIG. 1;

FIG. 3 is a schematic view explaining a pattern position determining method in a gold foil printing apparatus according to the present invention, in which essential parts of the gold foil printing apparatus are enlarged and illustrated;

FIG. 4 is a cross-sectional view showing a state where a transparent film having holes thereon and a pattern forming film are laminated on primary printing paper when a pattern position determining method is employed in a gold foil printing apparatus according to the present invention;

FIG. 5 is a plan view showing a state where a transparent film having holes thereon and a pattern forming film are laminated on primary printing paper when a pattern position determining method is employed in a gold foil printing apparatus according to the present invention;

FIG. 6 shows the pattern forming film on which holes are indicated in a pattern position determining method employed in a gold foil printing apparatus according to the present invention;

FIG. 7 is a cross-sectional view showing a pattern forming member which is obtained by etching the pattern forming film in a pattern position determining method employed in a gold foil printing apparatus according to an embodiment of the present invention;

FIG. 8 is a cross-sectional view showing a pattern forming member which is obtained by etching the pattern forming film in a pattern position determining method employed in a gold foil printing apparatus according to another embodiment of the present invention;

FIG. 9 is a flow-chart view explaining a process of obtaining a pattern forming member by etching the pattern forming film in a pattern position determining method employed in a gold foil printing apparatus according to an embodiment of the present invention;

FIG. 10 is a flow-chart view explaining a process of obtaining a pattern forming member by processing a numeric controlled (NC) carving work of the pattern forming film in a pattern position determining method employed in a gold foil printing apparatus according to another embodiment of the present invention;

FIGS. 11 and 12 are cross-sectional views showing a process of forming fixing holes in which a pattern forming member obtained by etching the pattern forming film in a pattern position determining method employed in a gold foil printing apparatus according to an embodiment of the present invention is drilled by a position determining groove; and

FIG. 13 is a cross-sectional view showing a pattern forming member in a pattern position determining method employed in a gold foil printing apparatus according to an embodiment of the present invention in which the pattern forming member is fixed to and coupled with an upper mold.

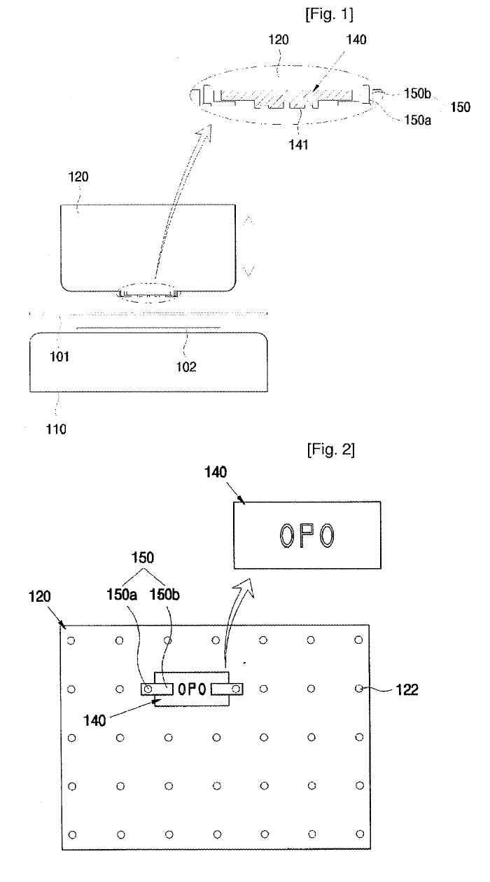

### BEST MODE FOR CARRYING OUT THE INVENTION

Hereinbelow, a pattern position determining method according to a preferred embodiment of the present invention will be described with reference to the accompanying drawings. Like reference numerals denote like elements through the following embodiments.

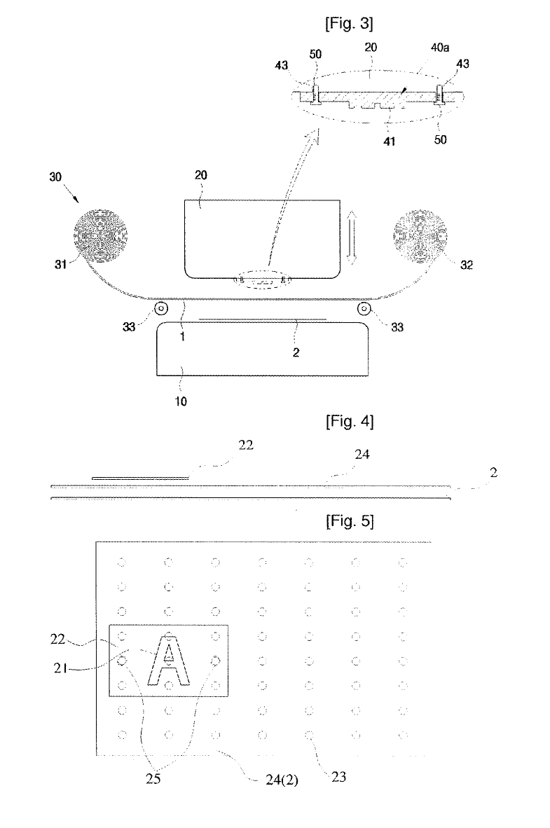

FIG. 3 is a schematic view explaining a pattern position determining method in a gold foil printing apparatus according to the present invention, in which essential parts of the gold foil printing apparatus are enlarged and illustrated. As shown in FIG. 3, a gold foil printing apparatus to which the pattern position determining method according to the present invention is applied includes a lower mold 10 on which printing paper 2 is put, an upper mold 20 which is positioned so as to be escalated on the upper portion of the lower mold 10 and compresses the printing paper 2 put on the lower mold 10 at high temperature, and a film loader 30 which loads a predetermined gold foil film 1 on the upper surface of the printing paper 2.

Of course, in addition to the above-described constructional elements, the gold foil printing apparatus includes a device for escalating the upper mold 20 with respect to the lower mold 10, such as for example, a LM (Linear Motion) guide for guiding the upper mold 20 to ascend and descend together with an escalating motor or cylinder.

Also, the gold foil printing apparatus includes a heater in order to compressively attach the gold foil film 1 onto the printing paper 2 at high temperature. Since the above-described elements are well-known, the detailed description thereof will be omitted.

As schematically shown in FIG. 3, the film loader 30 includes a raw material winding roller 31 on which a gold foil 1 is wound, a leftover winding roller 32 on which the leftover gold foil is rewound after the gold foil 1 has been released from the raw material winding roller 31 and left over after use, and a plurality of tension rollers 33 which pull the gold foil 1 tightly and give predetermined tension to the gold foil 1. However, the film loader 30 can be constructed using other known means.

A pattern printed film is formed on the lower surface of the upper mold 20 directed to the lower mold 10. The pattern printed film is called a pattern forming member 40a in which a printing pattern having various types of shapes such as letters, figures, alphabets, numbers, images and characters is printed on a pattern forming film having a printing pattern of a shape to be gold-foil-represented on the printing paper 2.

The pattern forming member 40a includes a printing pattern 41 whose printing pattern is uneven, and fixing holes 43 through which coupling members 50 are engaged at both sides of the pattern forming member 40a.

As shown in FIGS. 4 and 5, a transparent film 24 having holes 25 thereon and a pattern forming film 22 are laminated on primary printing paper 2 when a pattern position determining method is employed in a gold foil printing apparatus according to the present invention. Here, a reference numeral 21 denotes a pattern to be represented on the printing paper, and a reference numeral 23 denotes one of a plurality of latticed fixing holes.

As shown in FIG. 6, the pattern forming film 22 on which holes 25 are indicated is shown in a pattern position determining method employed in a gold foil printing apparatus according to the present invention.

Referring to FIGS. 4 through 6, a transparent film 24 on which latticed holes 23 are indicated as in an upper mold 20 on which latticed fixing holes are formed is placed on the printing paper 2. Then, a gold foil printing pattern forming film 22 is placed on the transparent film 24, to then indicate positions of fixing holes 25 on the gold foil printing pattern forming film 22 if a gold foil printing pattern forming position is determined.

FIG. 7 is a cross-sectional view showing a pattern forming member which is obtained by etching the pattern forming film in a pattern position determining method employed in a gold foil printing apparatus according to an embodiment of the present invention.

That is, as shown in FIG. 7, the gold foil printing pattern and positions of the fixing portion 42 are indicated on the pattern forming film 22 of FIG. 5, and then the pattern forming film 22 is etched with a predetermined metal member to thereby obtain a pattern forming member 40a from which a pattern 41 and the positions of the fixing holes 42 are protrudingly indicated. That is, the pattern forming member 40a includes at least two latticed fixing holes 42 each in which a drilling groove 42a is formed.

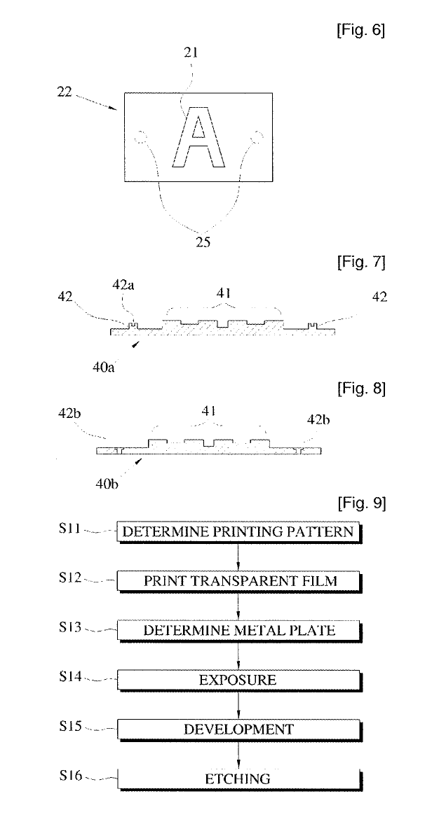

FIG. 8 is a cross-sectional view showing a pattern forming member which is obtained by etching the pattern forming film in a pattern position determining method employed in a gold foil printing apparatus according to another embodiment of the present invention.

As shown in FIG. 8, the gold foil printing pattern 41 and the positions of the fixing holes 42 are indicated on the pattern forming film 22, and then the pattern forming film 22 is etched with a predetermined metal member to thereby obtain a pattern forming member 40b from which the gold foil printing pattern 41 is protrudingly indicated. That is, the pattern forming member 40b includes at least two drilling grooves 42 indicated.

FIG. 9 is a flow-chart view explaining a process of obtaining a pattern forming member by etching the pattern forming film in a pattern position determining method employed in a gold foil printing apparatus according to an embodiment of the present invention.

The pattern position determining method will be described with reference to FIG. 9.

Referring to FIG. 9, the pattern position determining method includes the steps of: preparing a transparent film on which latticed holes are indicated as in an upper mold on which latticed fixing holes are formed (step 1); placing the transparent film on printing paper (step 2); placing a gold foil printing pattern forming film on the transparent film, to then indicate positions of fixing holes on the gold foil printing pattern forming film if a position of forming a gold foil printing pattern is determined (step 3); and etching the pattern forming film with a predetermined metal member to thereby obtain a pattern forming member from which a pattern protrudes and at least two of the positions of the fixing holes are indicated (step 4).

The uneven printing pattern 41 formed in the pattern forming member 40a or 40b is fabricated according to the steps of FIG. 9. As shown in FIG. 9, a printing pattern is determined (S11). The determined printing pattern is printed on a transparent film 22 (S12). The printed pattern is divided into a black portion where printing ink exists, and a white portion where printing ink does not exist. A metal plate such as zinc and bronze for forming the pattern 41 and the latticed fixing holes 42 by an etching process is determined (S13) and then pre-processed in which the metal plate is made of a material which is well etched. If the pre-processing of the metal plate is completed, a predetermined photosensitive resin layer is formed on one surface of the metal plate. After the predetermined photosensitive resin layer has been formed on one surface of the metal plate, the previously prepared pattern forming transparent film is disposed on the upper surface of the photosensitive resin layer and then exposed (S14). If exposure is executed, only light transmitting a portion through which light is transmitted among the printing pattern formed on the pattern forming transparent film reaches the photosensitive resin layer in the metal plate and thus leaves a corresponding portion. If exposure is completed, development is executed (S15). The metal plate is exposed at a corresponding portion from which the photosensitive resin layer is molten by development. If development is completed, etching is started. In the etching process, the developed material is ascertained, and then kept being put into an etching solution, and then a flushing is processed and then examined. The above-described processes are repeated a few times in the etching process. The metal plate having undergone the development is put into a predetermined etching solution to execute an etching process (S16). The etching solution forms unevenness in a corresponding portion of the metal plate which has been exposed by the exposure and development. Of course, a portion which does not react since light is not transmitted through the photosensitive resin layer does not react since the etching solution does not contact the corresponding portion of the metal plate. If etching is completed, the metal plate is put into a particular solution or surface-treated, so that the photosensitive resin layer remaining on the upper surface of the metal plate is completely removed. Accordingly, the pattern forming member 40a or 40b having the uneven printing pattern 41 is fabricated in which the latticed fixing holes 42 or 42a are formed in both sides of the uneven printing pattern 41.

The method of etching the pattern forming film 22 to obtain pattern forming members has been described. However, the pattern forming members can be obtained through a mechanical method other than exposure, development and etching of a metal plate, which will be described below in brief.

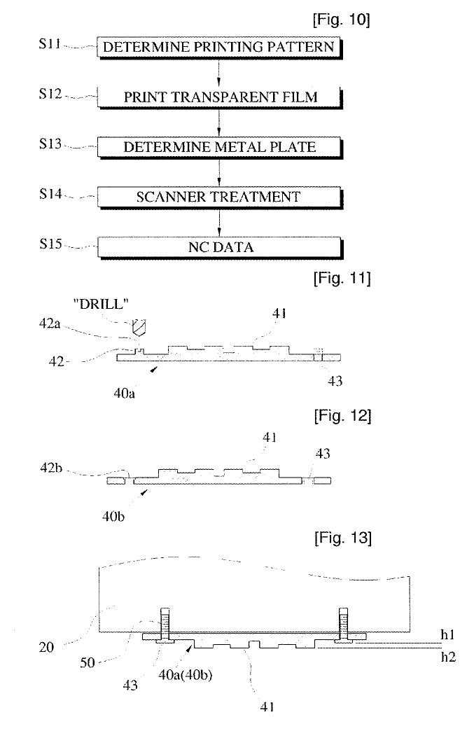

FIG. 10 is a flow-chart view explaining a process of obtaining a pattern forming member by processing a numeric controlled (NC) carving work of the pattern forming film in a pattern position determining method employed in a gold foil printing apparatus according to another embodiment of the present invention.

Referring to FIG. 10, the pattern position determining method includes the steps of: preparing a transparent film on which latticed holes are indicated as in an upper mold on which latticed fixing holes are formed; placing the transparent film on printing paper; placing a gold foil printing pattern forming film on the transparent film, to then indicate positions of fixing holes on the gold foil printing pattern forming film if a position of forming a gold foil printing pattern is determined; and numerically controlled engraving the pattern forming film on a predetermined metal member to thereby obtain a pattern forming member from which a pattern protrudes and at least two of the positions of the fixing holes are indicated.

The uneven printing pattern 41 formed in the pattern forming member 40a or 40b is fabricated according to the steps of FIG. 10. As shown in FIG. 10, a printing pattern is determined (S11). The determined printing pattern is printed on a transparent film 22 (S12). A metal plate such as zinc and bronze for forming the pattern 41 and the latticed fixing holes 42 is determined (S13) and then scanner-processed (S14). If the scanner-processing of the metal plate is completed, the metal plate is numerically-controlled engraved (S15). Accordingly, the pattern forming member 40a or 40b having the uneven printing pattern 41 is fabricated in which the latticed fixing holes 42 or 42a are formed in both sides of the uneven printing pattern 41.

FIGS. 11 and 12 are cross-sectional views showing a process of forming fixing holes 43 in which a pattern forming member 40a or 40b is obtained by etching the pattern forming film and is drilled into a drilling groove 42a and a drilling hole 42b, in a pattern position determining method employed in a gold foil printing apparatus according to an embodiment of the present invention. FIG. 13 is a cross-sectional view showing a pattern forming member in a pattern position determining method employed in a gold foil printing apparatus according to an embodiment of the present invention in which the pattern forming member is fixed to and coupled with an upper mold

As shown in FIGS. 11, 12 and 13, a fixing hole 43 is formed by a drilling machine in each drilling groove 42a or drilling hole 42b in the pattern forming member 40a or 40b, and then bolted or fixed to the upper mold corresponding to the holes 25 of the transparent film 24, to accordingly execute a gold foil printing process.

Here, it is preferable that the positions of the fixing holes 42 in the pattern forming member 40a or 40b protrude lower than that of the pattern 41, and a drilling groove 42a is formed at the center thereof.

Alternatively, in a gold foil printing method in which a gold foil is rotated around or transferred from a gold foil winding drum, a pressure roller ascends from the lower portion of the gold foil, and a stamping roller contacts the gold foil by a cam operation in the upper portion of the gold foil, the pattern forming member 40 may be coupled with and fixed to a cam portion of the stamping roller.

Also, it is preferable that the positions of the fixing holes 42 in the pattern forming member 40a protrude lower than those of the pattern 41, and a drilling groove 42a is formed at the center thereof.

In other words, as shown in FIGS. 7 and 8, the pattern forming member 40a or 40b employed in the pattern position determining method for the gold foil printing apparatus according to the present invention can be formed in various forms in which the position determining fixing holes 43 are formed on the bottom of the pattern forming member 40a or 40b, or penetrate the pattern forming member 40a or 40b.

As shown in FIG. 13, a height “h2” and bottom distance “h1” in the pattern 41 has a predetermined difference of height at a state where the pattern forming member is fixed to or coupled with the upper mold in a pattern position determining method of a gold foil printing apparatus according to the present invention. The pattern forming member 40a or 40b is fixed by use of a bolting member 50 having a flat head so that the pattern forming member is fixed lower than the protruded pattern 41.

The printing process of the gold foil printing apparatus having the pattern forming member 40a or 40b will be described below.

First, printing paper 2 to be printed is positioned at a predetermined position on the upper surface of the lower mold 10. Then, each roller 31 through 33 in the film loader 30 operates, the gold foil film 1 is positioned on the upper surface of the printing paper 2.

After the printing paper 2 and the gold foil film 1 have been prepared, the upper mold 20 is made to descend. Then, the pattern forming member 40a or 40b formed on the lower surface of the upper mold 20 compresses the printing paper 2 at high temperature through the gold foil film 1, so that the gold foil of the gold foil film 1 is stuck on the printing surface of the printing paper 2 in the form of unevenness. Accordingly the gold foil is formed on the printing paper 2.

After the gold foil has been formed on the printing paper 2 by a compression process for a predetermined time, the upper mold 20 is made to ascend upwards again and prepare the next process.

In the above-described embodiments, a film which will be printed on the printing paper has been specifically described as a gold foil film 1. However, a silver foil or the other position determining methods belonging to the scope of the present invention can be applied in the present invention.

The pattern position determining method for use in a gold foil printing apparatus according to the present invention is not only applied to a gold foil printing apparatus having an upper mold and a lower mold, but also applied to a gold foil printing apparatus using a rotating roller for compressing a gold foil film with an upper stamping roller and a lower pressing roller in which a pattern member is eccentrically positioned together with a cam portion at upper and lower positions during rotating the gold foil film through a gold foil film winding drum.

### Mode for the Invention

As described above, the present invention has been described with respect to particularly preferred embodiments. However, the present invention is not limited to the above embodiments, and it is possible for one who has an ordinary skill in the art to make various modifications and variations, without departing off the spirit of the present invention. Thus, the protective scope of the present invention is not defined within the detailed description thereof but is defined by the claims to be described later and the technical spirit of the present invention.

### INDUSTRIAL APPLICABILITY

As described above, a pattern position determining method according to the present invention can be applied to a gold foil printing apparatus.

1. A method of determining position of a pattern in a gold foil printer in which a pattern forming member is fixed to and coupled with an upper mold on which latticed fixing holes are formed, the pattern position determining method comprising the steps of: preparing a transparent film on which latticed holes are indicated as in an upper mold on which predetermined latticed fixing holes are formed on the bottom thereof; placing the transparent film on printing paper on which printing is performed; placing a gold foil printing pattern forming film on the transparent film, to then indicate positions of fixing holes transmitted on the gold foil printing pattern forming film, if a gold foil printing pattern forming position is determined; and etching or numerically controlled engraving the pattern forming film with a predetermined metal member, to thereby obtain a pattern forming member from which a pattern protrudes and at least two of the positions of the fixing holes are indicated.

2. The pattern position determining method according to claim 1, wherein the positions of the fixing holes in the pattern forming member protrude lower than that of the pattern, and a drilling groove is formed at the center thereof.

3. The pattern position determining method according to claim 1, wherein the positions of the fixing holes are formed on the bottom of the pattern forming member, and drilling holes are formed.

4. The pattern position determining method according to claim 1, wherein the fixing holes of the pattern forming member are formed by an etching process in correspondence to an engagement member, respectively.

5. The pattern position determining method according to claim 1, wherein the fixing holes of the pattern forming member are formed by a numerically controlled engraving process in correspondence to an engagement member, respectively.

6. The pattern position determining method according to claim 1, wherein the pattern forming member is applied to a gold foil printing method of a roller method.
